(19) United States
(12) Patent Application Publication
(10) Pub. No.: US 2004/0083889 A1
(43) Pub. Date: May 6, 2004

(54) Immersion heater for sparge vessel

(76) Inventor: Nathan C. Rawls, College Station, TX (US)

Correspondence Address: WONG, CABELLO, LUTSCH, RUTHERFORD & BRUCCULERI,, P.C., 20333 SH 249, SUITE 600, HOUSTON, TX, 77070, US

(21) Appl. No.: 10/288,390

(22) Filed: Nov. 5, 2002

(51) Int. Cl. B01D 19/00

(52) U.S. Cl. 95/241; 96/202; 96/218; 95/263

(57) ABSTRACT

A sparge vessel having a liquid sample is heated with an immersion heater to more completely purge the analytes from the sample to a sorbent trap. A thermocouple may be used to help the immersion heater maintain the sample at a desired temperature between 70 and 85 degrees C.

### BACKGROUND

The present invention relates generally to analyzing volatile organic compounds in air, water and soils. More particularly, the invention involves heating of samples in sparge vessels used for devices such as sample concentrators in the field of gas chromatography or liquid sample carbon analyzers.

Sample concentration techniques are used in purge-and-trap, headspace, and thermal desorption gas chromatography (“GC”) analysis. Highly volatile organic compounds with low water solubility may be extracted (purged) from the sample matrix by bubbling an inert gas (i.e., helium or nitrogen) through an aqueous sample. Purged sample components may be trapped in a tube containing suitable sorbent materials. When purging is complete, the sorbent tube may be heated and backflushed with the inert gas to desorb trapped sample components onto a capillary GC column. The column may be temperature programmed to separate the method analytes which then may be detected with a photoionization detector (PID), halogen specific detector, mass spectrometer, or carbon analyzer. The carbon analyzer may be organic or inorganic, or both. Tentative identifications may be confirmed by analyzing standards under the same conditions used for samples, and comparing results and GC retention times.

The purging device typically is a glass tube that may accept five to twenty-five ml. samples with a water column at least 5 cm deep. Gaseous volumes above the sample may be kept to a minimum to reduce “dead volume” effects. The purge gas passes through the water column in finely divided bubbles.

In addition to purge-and-trap methods and analyses, sample concentration gas chromatography is used in headspace analysis of liquids and solids, and in thermal desorption analysis of air tube samples. Headspace and thermal desorption techniques are not only used for environmental analyses, but also for clinical and industrial applications.

Different analytes in a sample may have different volatility and solubility characteristics. By heating the water sample, it is possible to accelerate the volatility and decrease the solubility of analytes to more completely purge each of the analytes out of solutions during the same time period.

Sample containers, or sparge vessels, are conventionally heated by placing a heater jacket, or pocket heater, around the glass outside surface of the sparge vessel. By contacting the outside surface of the sparge vessel, the pocket heater conducts heat to the sample in the vessel. Another type of heater assembly for sparge vessels is the tube type heater which fits snugly against the outside of the glassware. Pocket heaters and tube heaters are conventionally heated with electric current to temperatures as high as 100 degrees C., consuming 70 or more watts of power.

Although the pocket heater and tube heater are advantageous in that they are inexpensive and simple to use, a problem encountered in their use is delay for transferring heat from the jacket or tube to the inside of the sparge vessel. Even if the temperature of the jacket or tube heater is precisely regulated, that same temperature may not necessarily be reached uniformly inside of the vessel.

Conductive heating of samples with pocket heaters and tube heaters has other disadvantages and problems. For example, there is a time delay in first heating the jacket (for example, 5 minutes), and then transferring the heat to the sample (for example, an additional 7 or 8 minutes). Similarly, pocket heaters and tube heaters also may not heat all samples uniformly. This problem is in part due to the fact that the jacket does not have a uniform fit around the sparge vessel. Typically, a thermocouple is used to monitor the temperature of the jacket. However, even if the temperature of the jacket is known, the temperature of the sample may be significantly lower. Therefore, it may be necessary to compensate for this difference by increasing the jacket temperature.

As a result of these problems, each sample may be at a different temperature, and may be purged at a different rate. This means that interpretation of GC results and detection of analytes is less reliable and consistent from one sparge vessel to the next.

U.S. Pat. No. 5,337,619 assigned to O.I. Corporation discloses a radiant energy sample heater. The device includes a heat source that provides radiant heat energy in the form of visible or infrared light that is directed toward the sample through the transparent glass of the sparge vessel. A thermocouple in the sparge vessel may monitor the sample temperature and provide feedback of temperature to the heating source. The radiant heating device has advantages including a more uniform heating of each sample. However, the heating device consumes significant power, e.g., 375 watts to heat 25 ml. from ambient temperature of approximately 28 degrees C. to 80 degrees C. in approximately 4 minutes. Some of the power may be consumed heating components other than the sample, such as the glass sparge vessel, enclosures around the heat source, etc. Additionally, the heating device itself is at a temperature significantly higher than the desired sample temperature. An improved device and method for heating a liquid sample in a sparge vessel is needed. Although immersion heaters such as those made by Watlow Electric Manufacturing Company are available commercially, they have not been used or designed for use in heating liquid samples in sparge vessels.

### BRIEF DESCRIPTION OF THE DRAWINGS

FIG. 1 is a cross sectional view of the immersion heater in a sparge vessel according to one embodiment of the invention.

FIG. 2 is a cross sectional view of an immersion heater according to one embodiment of the invention.

### DETAILED DESCRIPTION

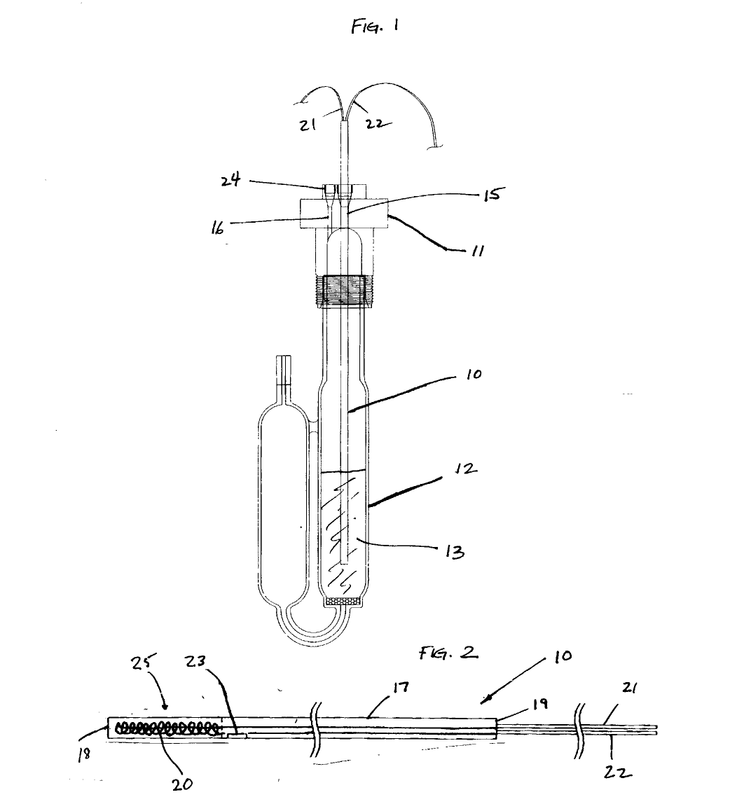

As shown in FIG. 1, immersion heater 10 is inserted through fitting 11 on the open end of sparge vessel 12. The sparge vessel may hold a liquid sample 13 that is to be purged using gas bubbles through outlet line 24 to a sorbent trap. A plurality of passages extend through the fitting including first passage 15 through which the immersion heater extends, and second passage 16 for the gas and purged analytes to flow through the outlet line to the trap. The immersion heater extends into the sparge vessel sufficiently so that it is immersed in the liquid sample in the sparge vessel.

As shown in FIG. 2, immersion heater 10 includes sheath 17 which is an elongate tubular element having a generally circular cross section and a sufficiently small diameter and volume so that it will displace only a small volume of the sample. The sheath may have an external diameter of less than M inch. In one embodiment of the invention, the sheath has an external diameter of 0.125 inches, a total length of 7.625 inches, and a heated length of 2.25 inches. Thus, in one embodiment of the invention, the volume of the sheath immersed in the sample, as well as the displaced sample, is less than 0.10 cubic inches. First end 18 of the sheath is immersed in the sample that is transmitted into and held in the sparge vessel, and second end 19 is inserted through and attached to the first passage in the fitting. The sheath may be metallic or other non-corrosive and/or chemically inert material that can withstand high temperatures, such as Incoloy® 800, 316 stainless steel, or other nickel/chromium alloys including materials used for sample needles and other components that may be immersed in the liquid sample. The first end of the sheath may be capped.

Heating element 20 is positioned inside the sheath adjacent the first end of the sheath. The heating element may be a resistance wire such as nickel-chromium wire and may be wound on a supporting core. The heating element zone 25 may be less than one half the length of the sheath. For example, in one embodiment of the invention, the heating element extends 2.25 inches from the first end of the sheath. Insulating material such as magnesium oxide may be used to fill the sheath between the heating element and sheath. Lead wires 21, 22 or other electrical connections are connected to the heating element and may extend out the second end of the sheath to a power source. The power source may be direct current, alternating current, or a combination of direct and alternating current. In one embodiment of the invention, the heating element may consume power of 30 to 120 watts, and preferably 50 to 100 watts.

In one embodiment of the invention, thermocouple 23 is coupled to the sheath adjacent the first end and slightly spaced above heated zone 25. The thermocouple senses the temperature adjacent to and slightly above the heated zone of the sheath. For example, the thermocouple junction may be approximately 0.25 inches above the heated zone. The thermocouple may be in contact with the sheath and electrically isolated from the heating element. Alternatively, a thermocouple, RTD or other temperature sensing device may be immersed in the sample without contacting the sheath, in or adjacent the heated zone.

The thermocouple, RTD or other temperature sensing device may be connected to the power source directly or through a controller or other programmable logic. Using the thermocouple, the power source may be activated, deactivated, regulated and/or controlled to provide sufficient power to the heating element to reach and maintain the sample at a desired temperature, typically between 40 and 85 degrees C.

In one embodiment, a method includes transmitting a five to twenty-five ml. liquid sample into a sparge vessel. Power is provided to the heating element of an immersion heater, one end of which is immersed in the liquid sample. The sample is heated to a desired temperature of 40 to 85 degrees C. During or after the sample heating process, purge gas may be bubbled through the sample to purge analytes, i.e., volatile chemicals, from the sample onto a sorbent trap. During purging, a thermocouple may be used to measure and provide temperature information to the power source so that sufficient power may be provided to maintain the sample at the desired temperature.

In one embodiment of the invention, a 120 watt immersion heater raised the temperature of a 25 ml. sample in a sparge vessel from approximately 28 degrees C. up to 80 degrees C. in 1.5 minutes, and a 30 watt immersion heater raised the temperature of a 25 ml. sample in a sparge vessel, from approximately 28 degrees C. up to 80 degrees C. in 4.25 minutes.

The immersion heater may be used in purge-and-trap systems and similar devices in gas chromatography applications, carbon analyzers including organic or inorganic carbon analyzers, and other applications or devices where chemicals are purged from a liquid sample for analysis.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. An apparatus comprising:
a sparge vessel to hold a liquid sample, the sparge vessel having a fitting attached to one end thereof, the fitting having a first passage and a second passage, the second passage connected to a sorbent trap; and
an immersion heater positioned in the sparge vessel, including a sheath with a first end immersed in the liquid sample and a second end extending through the first passage, a heating element inside the first end of the sheath, an electrical connection between the heating element and a power source, and a thermocouple attached to the sheath adjacent the first end thereof and electrically connected to the power source.

2. The apparatus of claim 1 wherein the heating element is a resistance wire.

3. The apparatus of claim 1 wherein the power source is direct current.

4. The apparatus of claim 1 wherein the heating element inside the first end of the sheath extends less than one half the length of the sheath.

5. A method comprising:
transmitting a liquid sample into a sparge vessel having a fitting attached to one end thereof, the fitting having a plurality of passages extending therethrough;
heating the liquid sample with an immersion heater having a first end immersed in the liquid sample, the first end having an internal heating element and a second end extending through a passage in the fitting and having an electrical connection to a power source; and
bubbling a gas into the sparge vessel, the gas exiting the sparge vessel through a passage in the fitting connected to a sorbent trap.

6. The method of claim 5 further comprising sensing the temperature with a thermocouple connected to the immersion heater.

7. The method of claim 6 further comprising regulating the temperature with the thermocouple connected to the power source.

8. The method of claim 5 wherein the immersion heater raises the temperature to between 40 and 85 degrees Centigrade.

9. The method of claim 5 wherein the immersion heater includes an elongate sheath.

10. The method of claim 5 wherein the internal heating element is a resistance wire.

11. An apparatus comprising:
a metal sheath having a circular cross section, a first end and a second end;
a resistance wire in the first end and extending less than one half the length of the metal sheath;
an insulating material between the resistance wire and the metal sheath;
an electrical connection between the resistance wire and a power source; and
a sparge vessel fitting holding the second end of the metal sheath and through which the electrical connection extends.

12. The apparatus of claim 11 wherein the metal sheath has an outside diameter of less than M inch.

13. The apparatus of claim 11 further comprising a thermocouple attached to the metal sheath and the power source.

14. The apparatus of claim 11 further comprising a plurality of passages extending through the fitting.
